(19) United States
(12) Patent Application Publication
(10) Pub. No.: US 2020/0402071 A1
(43) Pub. Date: Dec. 24, 2020

(54) SYSTEM AND METHODS FOR TRANSPARENT ACCOUNT CREATION

(71) Applicant: HALLEMAN BRADLEY INC., Santa Monica, CA (US)

(72) Inventors: Zach Bruhnke, Los Angeles, CA (US); Dmitry Gritskevich, San Francisco, CA (US); Stephen Germain Cassiere, III, Leander, TX (US); Yu Xuan Zheng, Vancouver B.C. (CA); William Lessard, III, Culver City, CA (US)

(21) Appl. No.: 16/905,600

(22) Filed: Jun. 18, 2020

Related U.S. Application Data
(60) Provisional application No. 62/863,723, filed on Jun. 19, 2019.

(51) Int. Cl. G06Q 30/00

(52) U.S. Cl. CPC G06Q 30/016

(57) ABSTRACT

The disclosed embodiments relate to dynamic performance of no application account tasks. A no application account task can include opening a new account for a client. A client interface can be presented on a client device associated with the client. The system can detect a request from the client device to generate the new account for the client that includes a single action on the client interface. The new account can be generated by mapping information relating to the new account with a client identifier associated with the client. The client interface can be updated to indicate that the new account is available to the client.

### CROSS-REFERENCE TO RELATED APPLICATIONS

The present application claims priority to U.S. Provisional Patent Application No. 62/863,723, titled “IMPLEMENTING A NO APPLICATION UNDERWRITING PROCESS,” and filed Jun. 19, 2019, wherein the entirety of which is incorporated by reference hereto.

### BACKGROUND

Many actions of people are tracked using various identifiers associated with each person (e.g., a set of credentials, a government-issued identification number, personal information). For example, the credit history of a person may be tracked by a credit-tracking entity by associating credit-effecting events relating to the person with a government-issued identification number that identifies that person. In many cases, a tracked series of events associated with a person may be given a score or rating to identify a relative quality of the tracked series of events. For example, a credit-tracking entity may track all credit-effecting events and issue a credit score for a person representing various credit-based factors for that person.

Various entities may use scores associated with a person to make decisions for that person. As an example, an underwriting company may inspect a credit score associated with a person to decide whether the person is credit-worthy and should be issued a loan (or an underwriting process). Generally, an entity may receive an application for services from an applicant, and the entity may make a decision on whether to accept the terms of the application for that applicant based on information relating to the applicant.

In many cases, in order to make such a decision, a provider (e.g., a credit-issuing company) may retrieve multiple sets of information from various sources. For example, a credit-issuing company (or “underwriter”) may transmit a request for a credit score for a person from multiple credit tracking entities. Additionally, the underwriter may transmit requests for other information from various sources to determine a credit-worthiness of the person.

### BRIEF DESCRIPTION OF THE DRAWINGS

FIG. 1 illustrates an example environment in which the present embodiments can be implemented.

FIG. 2 is a block diagram of an example client interface.

FIG. 3 illustrates an example new account summary interface.

FIG. 4 illustrates an example block diagram of a customer device and a provider device.

FIG. 5 illustrates an example flow diagram to enable a client to implement a no application account task procedure.

FIG. 6 illustrates an example method to implement a no application account task action.

FIG. 7 is a flow diagram of a process to open an account for a client based on a single action.

FIG. 8 is a block diagram illustrating an example of a processing system in which at least some operations described herein can be implemented.

The drawings and tables depict various embodiments for illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

Many actions taken by individuals can be monitored/tracked using various identifiers associated with each person (e.g., credentials, government-issued identification number, personal information). For example, an entity (e.g., a bank, financial services provider) can open accounts for clients and maintain funds for clients.

Additionally, a client may have multiple accounts opened with an entity. For example, a first account can include a checking account, while a second account can include a savings account or a credit card account. In many cases, opening a new account for a client can include a multi-step process that includes receiving a request to open the new account, review the request to determine whether the client qualifies for the new account, creating the new account for the client, etc.

However, in many cases, an account opening process can be time and/or computational resource intensive, as the process may include an operator processing each request to open a new account. This may result in a delay in opening of an account for a client.

Further, in many cases, a webpage can allow for a client to request to open a new account or obtain approval for a product. However, if a client makes such a request, the client may be redirected from the webpage to provide other information for a provider to make a determination as to whether a new account can be opened or if the client is approved for a product. Redirecting the client from a webpage can reduce user experience, as the client is unable to perform various actions on a common interface.

The embodiments set forth below represent the necessary information to enable those skilled in the art to practice the embodiments and illustrate the best mode of practicing the embodiments. Upon reading the following description in light of the accompanying figures, those skilled in the art will understand the concepts of the disclosure and will recognize applications of these concepts that are not particularly addressed herein. These concepts and applications fall within the scope of the disclosure and the accompanying claims.

Embodiments may be described with reference to particular computer programs, system configurations, networks, etc. However, those skilled in the art will recognize that these features are equally applicable to other computer program types, system configurations, network types, etc. For example, although the term “Wi-Fi network” may be used to describe a network, the relevant embodiment could be deployed in another type of network.

Moreover, the disclosed technology can be embodied using special-purpose hardware (e.g., circuitry), programmable circuitry appropriately programmed with software and/or firmware, or a combination of special-purpose hardware and programmable circuitry. Accordingly, embodiments may include a machine-readable medium having instructions that may be used to program a computing device (e.g., a base station or a network-connected computer server) to perform processing tasks as described herein.

### Terminology

The purpose of terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating,” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, terms such as “connected,” “coupled,” or the like, may refer to any connection or coupling, either direct or indirect, between two or more elements. The coupling or connection between the elements can be physical, logical, or a combination thereof.

References to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the words “comprise” and “comprising” are to be construed in an inclusive sense rather than an exclusive or exhaustive sense (i.e., in the sense of “including but not limited to”).

The term “based on” is also to be construed in an inclusive sense rather than an exclusive or exhaustive sense. Thus, unless otherwise noted, the term “based on” is intended to mean “based at least in part on.”

The term “module” refers broadly to software components, hardware components, and/or firmware components. Modules are typically functional components that can generate useful data or other output(s) based on specified input(s). A module may be self-contained. A computer program may include one or more modules. Thus, a computer program may include multiple modules responsible for completing different tasks or a single module responsible for completing multiple tasks.

When used in reference to a list of multiple items, the word “or” is intended to cover all of the following interpretations: any of the items in the list, all of the items in the list, and any combination of items in the list.

The sequences of steps performed in any of the processes described herein are exemplary. However, unless contrary to physical possibility, the steps may be performed in various sequences and combinations. For example, steps could be added to, or removed from, the processes described herein. Similarly, steps could be replaced or reordered. Thus, descriptions of any processes are intended to be open-ended.

### System Overview

The present embodiments relate to implementing a transparent account creation process. The transparent account creation process can allow for creation of an account based on a single action that efficiently generates a new account for a client by mapping account information to client information. This can provide a transparent and efficient account opening process that can increase client experience and efficiency in use of computational resources.

The present system (or simply “provider”) may generate interfaces (e.g., a webpage, mobile application page) for the client that includes the products that the client has been approved based on the provider determining that the client information is within a specified range for the products. Upon a selection of a product shown on the display by the client interacting with the client device, the provider may approve the client for access to the product.

A provider (e.g., underwriter) may receive an identifier associated with a client. Based on identifying the client, the provider may transmit a webpage to a device associated with the client. The client device may display information that identifies a product and display an indicator (e.g., a button) that a single action (e.g., a mouse click) that a client may perform to confirm the creation of an account associated with the product. The provider may open/create an account that associates the client to a product selected by the client. Upon creation of the account, a client may access the product (e.g., access funds for a loan).

The present embodiments can provide an interface that allows for a user to open a new account of a provider with a single action. The provider can inspect client information to process the request, approve the request, and generate a new account for the client. Particularly, the client interface can allow for the client to open a new account without being redirected from the interface, which can include user experience in interacting with the client interface.

Further, the present system can generate a series of products that the client is approved without previous requests from the client. For example, the system can process client information to determine a number of products that the client is approved. The system can update a client interface to provide a description of the number of products that the client is approved. Responsive to obtaining an indication that the client accepts an offer for a product, the system can automatically enroll the client with the product and provide information related to the product. The client can enroll/subscribe to a product without being redirected from the client interface.

In some embodiments, a method to automatically generate a new account for a client includes generating a client interface to be presented on a client device associated with the client. The client interface can include a webpage/application displaying on a client device that includes client-specific information.

The method can include retrieving client information associated with the client from a client information database based on identifying at least one entry that corresponds with the client. Client information can include various information relating to a client, such as personal information, credit history information, payment information, active accounts, etc.

In some embodiments, the method can include transmitting a request for client information to multiple third-party devices, wherein the request is encrypted and includes the client identifier. The method can also include receiving requested client information from the multiple third-party devices. The method can also include deriving a type of information included in the requested client information. The method can also include storing the requested client information in the client information database based on the derived type of information of the requested client information.

In some embodiments, the method includes detecting an indication on the client interface indicating a request for presentation of products on the client interface. The method also includes setting a flag associated with the client identifier, wherein updating the client interface to include a display of the first product that is capable of being selected by the client is performed responsive to identifying the flag associated with the client identifier.

In some embodiments, the client interface includes a series of buttons indicative of no application account tasks capable of being performed for the client. The single action can include a selection of a first button of the series of buttons on the client interface corresponding to generating the new account.

Responsive to determining that the client information is within the approval threshold of the first set of product information for the first product, the method can include updating the client interface to include a display of the first product that is capable of being selected by the client. For example, the display of the first product can include a portion of the interface that provides information relating to the product and can allow for a client to select the first product.

In some embodiments, the method can include presenting a subset of products on the client interface in an order. The first product can be included in the subset of products. The client information may be within approval thresholds of product information for each product of the subset of products.

In some embodiments, the method can include deriving the order of the subset of products based on the product information for each product of the subset of products based on a relevance of each product to the client information and a rating of each product.

The method can include detecting a request from the client device to generate the new account for the client, the request comprising a single action on the client interface presented on the client device. The new account can include a first account associated with the first product or a second account that includes an account type that is different than an account type of a primary account associated with the client.

The method can include generating the new account by mapping information relating to the new account with a client identifier associated with the client. In some embodiments, generating the new account can include populating account description fields using client information maintained by the client information database.

The method can include storing the information relating to the new account and the client identifier in an account database.

The method can include updating the client interface to indicate that the new account is available to the client.

### Example Environment Overview

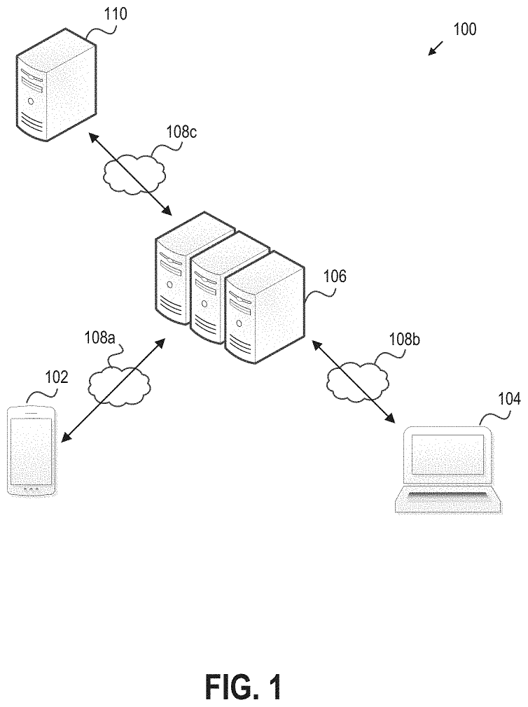

FIG. 1 illustrates an example environment 100 in which the present embodiments can be implemented. The environment 100 can include one or more client devices 102. Each client device 102 can include a network-accessible device (e.g., a smartphone, tablet, computer) capable of presenting a client interface to a client. The client interface can include a webpage/application provided by network-accessible server system 106 that is specific to the client.

As described in greater detail below, the client interface can allow for an individual (e.g., an employee of the vendor) to view account information, take an action (e.g., open a new account, subscribe to a product), etc., without being redirected from the client interface.

The environment can include a provider device 104. The provider device 104 can include a network-accessible device associated with a provider of the products offered to the client. The provider device 104 can allow for a provider to view various data, such as client data, database information, analytics, etc.

The environment 100 can include a network-accessible server system 106. The network-accessible server system 106 can include one or more computing devices (e.g., servers) capable of storing information and performing processing tasks as described herein.

The devices included in the environment 100 can communicate via networks 108a-c. The network(s) 108a-c can include personal area networks (PANs), local area networks (LANs), wide area networks (WANs), metropolitan area networks (MANs), cellular networks, the Internet, etc. Additionally or alternatively, the network-accessible server system 106 can be communicatively coupled to devices device(s) in the environment 100 over a suitable wired/wireless communication protocol.

The network-accessible server system 106 can communicate with a third-party server 110. The third-party server 110 can include a device associated with a third party (e.g., a client information storage node, a credit monitoring node). The network-accessible server system 106 can connect with third-party server 110 via an application programming interface (API), a plugin, etc. The network-accessible server system 106 and third-party server 110 can securely communicate via a suitable encryption technique. For example, the network-accessible server system 106 can securely retrieve credit information from the third-party server 110.

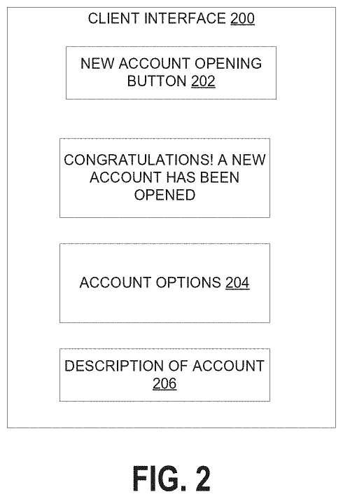

FIG. 2 is a block diagram of an example client interface 200. The client interface can represent a display (e.g., a webpage, mobile application page) executing on a client device (e.g., smartphone, computer).

In some embodiments, a network-accessible server system 106 (e.g., a server or series of interconnected servers) may transmit the webpage to a client device via a network. In another embodiment, the network-accessible server system 106 may transmit the webpage to a mobile application executing on the client device. As noted above, the network-accessible server system 106 may transmit a webpage with information that is specific or unique to a client.

The display can allow for a new account to be opened (e.g., open account 214). The new account can be for any of a variety of account types (e.g., checking, savings, credit card, brokerage). An open account button can allow for a client to open a new account in a single action (e.g., a single click). In some instances, the new account is a secondary account opened on behalf of a client that has previously opened a primary account. The system can process client information to open a new account, as is described in greater detail below.

As shown in FIG. 2, the display may include a new account opening button 202. This can allow for a client to have a new account opened responsive to a single action (e.g., a single click on the button 202). In some embodiments, a series of buttons relating to different account types can be provided on the client interface 200.

The client interface 200 can include an indication that a new account has been opened. For instance, after a selection of a button to open a new account and successful opening of the new account, the client interface 200 may indicate a successful opening of the new account.

The client interface 200 may include account options 204. The account options 204 can include an ability for the client to view/modify features of the account. For example, an account configuration or a closing date for the account can be modified.

The client interface 200 can include a description of the account 206. For example, the account options 204 can view terms, restrictions, a closing date, etc., relating to the account.

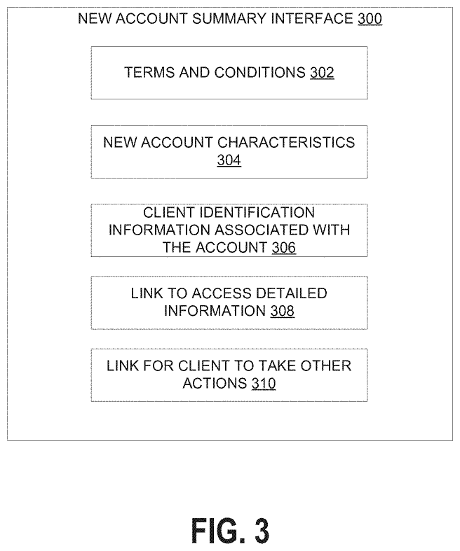

FIG. 3 illustrates an example new summary interface 300. For instance, the new summary interface 300 can include a confirmation message confirming the opening of an account. The new summary interface 300 may confirm the selection of an account and approval of the account for the client. The display can indicate that the account has been approved, an indication that the account has been created for the client, an option to close the account, etc.

The confirmation message may include a confirmation that the user has successfully opened an account and funds are available immediately. This may be given in web page or mobile app form illustrating the confirmation of a new account opening. There may include a reference to where client may access full account information, terms, and conditions. There may include a link enabling client to close account in case of an error.

The display of the confirmation message may include a summary description of the new account that was opened by the client. For instance, the new account summary interface 300 can include terms and conditions 202. Terms and conditions 302 can include various terms of the account, such as a length of a term for the product, an interest rate, etc. As another example, the new product summary interface 300 can include new account characteristics 304 providing characteristics of the account.

The new account summary interface 300 can include client identification information associated with the account 306. This information can include identifiers (e.g., account numbers) associated with the account. From these identifiers, the client and/or account can be identified by the provider.

The new product summary interface 300 can include a link to access detailed information 308. This link can redirect the client device to a webpage to view detailed information, such as a detailed listing of all terms of the account, for example.

The new product summary interface 300 can include a link for the client to take another action 310. The link can redirect the client device to other pages to take actions, such as cancel the account, request a modification to the terms of the product, etc.

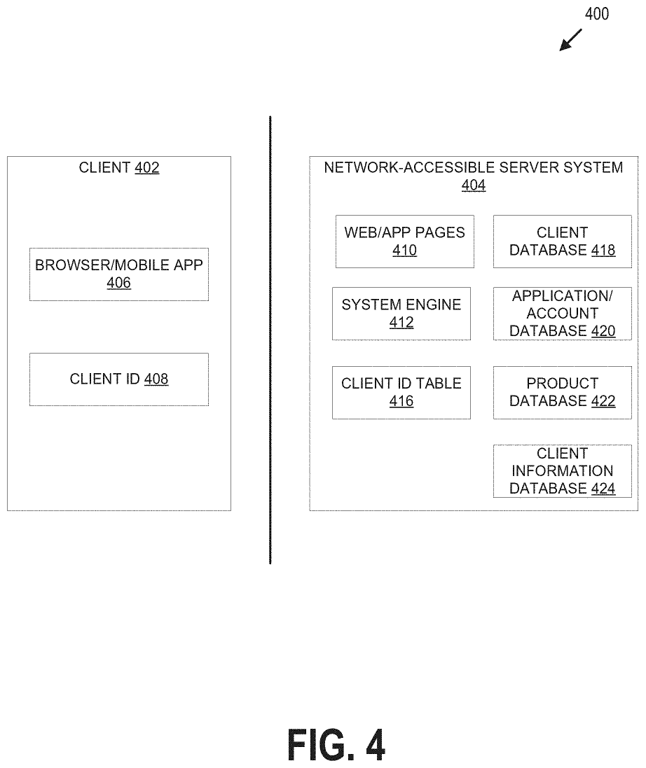

FIG. 4 illustrates an example block diagram 400 of a customer device and a provider device. As shown in FIG. 4, a client device 402 may communicate with a provider device 404 via a network (e.g., the internet).

The client device may include a web browser/mobile app 406 configured to facilitate communications over a network such as the internet and display a webpage on a display of the customer device. The customer device may store and transmit a customer identifier 408 (e.g., a credential, number, value, internet protocol (IP) address, etc.) associated with the customer that identifies the customer.

A network-accessible server system 404 may include a device (e.g., a server) or series of interconnected server associated with a provider (e.g., an underwriter), such as network-accessible server system 106 as described with respect to FIG. 1. The network-accessible server system 404 may include information to render a webpage for a client (e.g., web/app pages 410). The web/app pages 410 can include template web pages to render for various client devices and the network-accessible server system 404 can populate the template web pages with client-specific data. The webpage may be transmitted to a client device 402 via a network (e.g., the internet).

The network-accessible server system 404 can include a system engine 412 may receive a Hypertext Transfer Protocol (HTTP) request to access a webpage or application page associated with the customer identified by a Uniform Resource Locator (URL) and provide the pages to the customer device. The network-accessible server system 404 may include information associated with a plurality of customers, where information associated with each customer is identifiable by a customer identifier.

The network-accessible server system 404 may include a client database 418. The client database 418 may include a listing of client or potential client associated with the provider. The clients in the database 418 may be identified by identifiers provided by each client. The client database 418 can include entries associated with a client, wherein the network-accessible server system 404 can retrieve client-specific information from the client database 418 to open an account or provide products for a client as described herein.

The network-accessible server system 404 may include an application/account database 420. The account database 420 may include a listing of all accounts and applications maintained by the provider. The account database 420 may include information relating to each account, such as a customer identifier associated with the account. The network-accessible server system 404 can retrieve account information and/or application information relating to a client from account database 420.

The network-accessible server system 404 may include a product database 422. The product database may include various products (e.g., loans, new accounts, credit cards, mortgages) offered by the provider and other information relating to the product (e.g., terms, interest rates, qualification information).

The network-accessible server system 404 may include a client information database 424. The client information database 424 may include personal identification and underwriting information associated with various clients.

The network-accessible server system 404 may include a client identifier table 416 associating each customer to a known customer identifier. The client identifier table 416 may include a listing of all client and applicants and a client identifier associated with each client/applicant in order to identify a client.

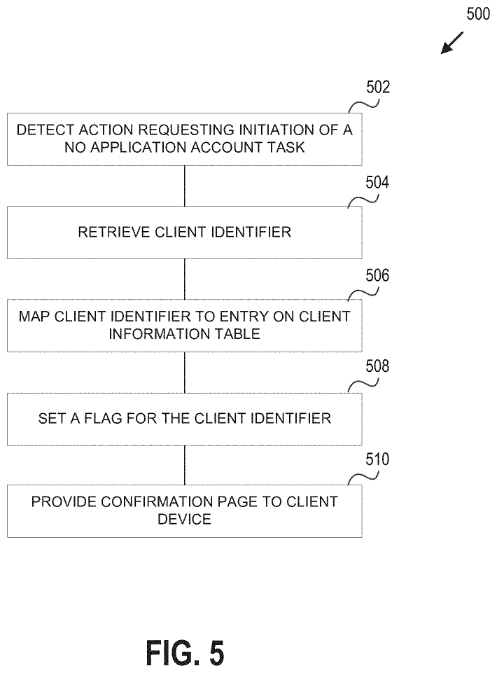

FIG. 5 illustrates an example flow diagram 500 to enable a client to implement a no application account task procedure. A no application account task can include any of opening a new account for a client or approving a client for a product based on an action by the client without performing a traditional application process.

To implement the no application account task, a provider device (e.g., network accessible server system) can detect an action by the client requesting initiation of the no application account task (block 502). For example, the action can include a single click of a button on a client interface requesting a new account be opened for a client. As another example, the action can include a client indication to accept an offer for a product approved for the client. The client interface on a client device can include a listing of account actions that can be taken with respect to a client account, and initiation of the no application account task can be based on a selection of any of the account actions.

The method may include retrieving the client identifier from the client (block 504). The client identifier may be received over a network using a suitable wired/wireless communications protocol.

The method may include mapping the client identifier to a client by mapping the client identifier to a listing on a client table (block 506). Mapping the client identifier to a client may identify a client and facilitate retrieval of other information associated with the client.

The method may include setting a flag for the client/client identifier (block 508). The provider may set a flag in the client table indicating that a no application account task is enabled for the associated client ID. The flag may be a tag or indicator indicating that the client is enabled to utilize no application account tasks. The provider may inspect the client identifiers for flags to determine which clients have enabled no application account task.

The method may include transmitting a return confirmation page to the client (block 510). The provider system may send a confirmation to the client system. Accordingly, in a next time a client attempts to apply for a product, the provider may associate the client with a new client identifier that indicates that no application account tasks are enabled.

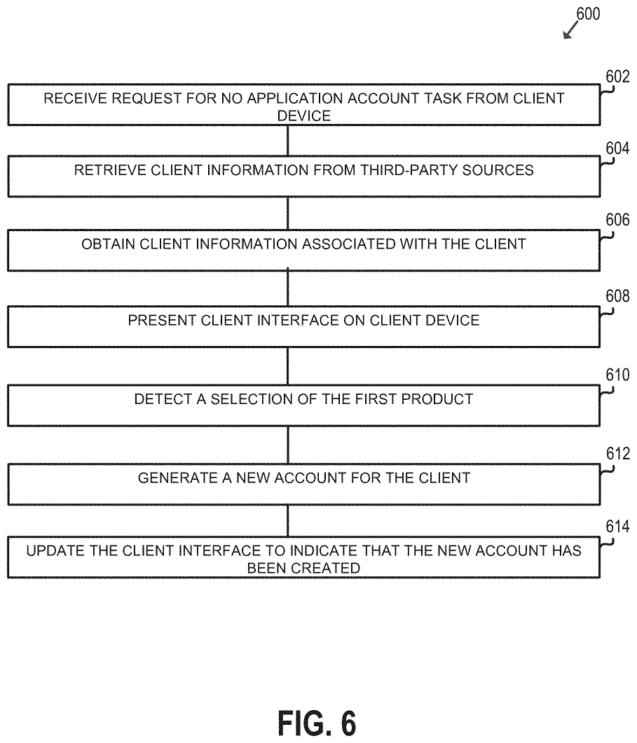

FIG. 6 illustrates an example method 600 to implement a no application account task action. The method may include receiving a request for a no application account task from a client device (block 602). The request may include a client identifier identifying the client. The new application account task can include creating a new account for a client or providing one or more products that the client is approved.

In some embodiments, the method may include mapping a client identifier (ID) to a known client listed in a listing of known clients to identify a client. A provider may access a client table to translate a client ID to a known client listed in the client table.

The method may include retrieving client information from third-party sources (block 604). This can include requesting client information (e.g., credit history, credit scores, payment amounts) from third-party devices (e.g., credit monitoring entities). The request can be obfuscated/encrypted using a suitable technique and can securely communicate client information between the present system and third-party devices.

The method may include obtaining client information associated with the client (block 606). Retrieving client information may include any of accessing a database on the provider device storing the client information or receiving the client information from external devices over a network. For instance, this can include identifying entries in client information databases based on the client ID to retrieve client information.

The method may include presenting the client interface to a device associated with the client (block 608). The client interface can include client-specific information, such as active accounts for the client, products available to the client, etc.

The method may include detecting a selection of the first product (block 610). This can include a single action (e.g., a single click of a button on the client interface).

The method may include generating a new account for the client with the terms associated with the first product (block 612). This can include mapping a new account with client information and storing the new account in a suitable database.

The method may include updating the client interface to indicate that the new account has been created (block 614).

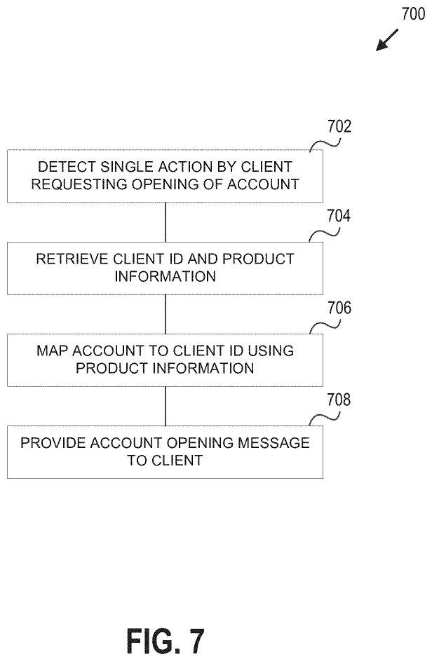

FIG. 7 is a flow diagram of a process 700 to open an account for a client based on a single action. This process can include a process in which an account is generated and tied to a client through a single user action (e.g., a single click on a client interface).

The process can include detecting a single action by a client requesting opening of an account (block 702). The opening of an account can include an additional account associated with the client (e.g., a checking account, savings account, credit card account, mortgage account). The provider can utilize previously-retrieved client information to open a new account for the client efficiently and accurately.

The process can include retrieving a client identifier (ID) and product information (block 704). The product information can include information relating to a product, such as the new account to be opened for a client. For instance, this can include account terms, restrictions, etc. The product information can include information to generate an account number for the new account.

The process can include mapping the newly-created account to the client ID using the product information (block 706). This can include adding an entry in an account database to include the new account and the client ID. The new account can be generated using the product information.

The process can include providing an account opening message to the client (block 708). The account opening message can include a message or a client interface indicating to the client that the new account has been opened. This message can include various account information.

### Processing System

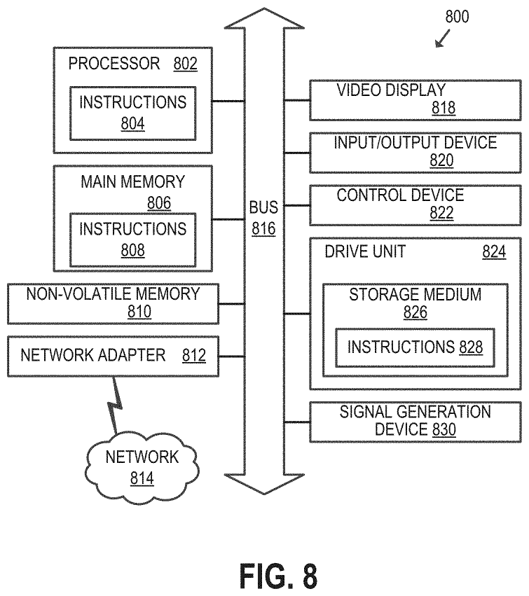

FIG. 8 is a block diagram illustrating an example of a processing system in which at least some operations described herein can be implemented. For example, some components of the processing system 800 can be hosted on an electronic device as described in the present embodiments.

The processing system 800 can include one or more central processing units (“processors”) 802, main memory 806, non-volatile memory 810, network adapter 812 (e.g., network interface), video display 818, input/output devices 820, control device 822 (e.g., keyboard and pointing devices), drive unit 824 including a storage medium 826, and signal generation device 830 that are communicatively connected to a bus 816. The bus 816 is illustrated as an abstraction that represents one or more physical buses and/or point-to-point connections that are connected by appropriate bridges, adapters, or controllers. The bus 816, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (i.e., “Firewire”).

The processing system 800 can share a similar computer processor architecture as that of a desktop computer, tablet computer, personal digital assistant (PDA), smartphone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 800.

While the main memory 806, non-volatile memory 810, and storage medium 826 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 828. The term “machine-readable medium” and “storage medium” shall also be taken to include any medium that is capable of storing, encoding, or carrying a set of instructions for execution by the processing system 800.

In general, the routines executed to implement the embodiments of the disclosure can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in a computing device. When read and executed by the one or more processors 802, the instruction(s) cause the processing system 800 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 810, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 812 enables the processing system 800 to mediate data in a network 814 with an entity that is external to the processing system 800 through any communication protocol supported by the processing system 800 and the external entity. The network adapter 812 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 812 can include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The techniques disclosed herein can include a tool or system to extract information from a design drawing to supplement the capabilities of a product manufacturing process. The present embodiments can assist in the generation/modification of a quote/estimate, the generation of manufacture feedback, the manufacturing scheduling/ordering process, etc.

### Remarks

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

What is claimed is:

1. A method to automatically create a new account for a client, the method comprising:
generating a client interface to be presented on a client device associated with the client;
retrieving client information associated with the client from a client information database based on identifying at least one entry that corresponds with the client;
detecting a request from the client device to generate the new account for the client, the request comprising a single action on the client interface presented on the client device;
generating the new account by mapping information relating to the new account with a client identifier associated with the client;
storing the information relating to the new account and the client identifier in an account database; and
updating the client interface to indicate that the new account is available to the client.

2. The method of claim 1, further comprising:
transmitting a request for client information to multiple third-party devices, wherein the request is encrypted and includes the client identifier;
receiving requested client information from the multiple third-party devices;
deriving a type of information included in the requested client information; and
storing the requested client information in the client information database based on the derived type of information of the requested client information.

3. The method of claim 1, wherein the client interface includes a series of buttons indicative of no application account tasks capable of being performed for the client, and wherein the single action includes a selection of a first button of the series of buttons on the client interface corresponding to generating the new account.

4. The method of claim 3, wherein each button of the series of buttons relates to a different account type, and wherein selection of the first button indicates a request to open the new account of a first account type.

5. The method of claim 1, wherein generating the new account further includes populating account description fields using client information maintained by the client information database.

6. The method of claim 1, further comprising:
for each account type of a series of account types, comparing the client information with a set of qualification criteria indicative of whether the client is qualified for each account type, wherein generating the new account by mapping information relating to the new account with a client identifier associated with the client is performed responsive to determining that the client is qualified for a first account type associated with the new account.

7. The method of claim 1, further comprising:
detecting an indication on the client interface indicating a request for presentation of products on the client interface; and
setting a flag associated with the client identifier, wherein updating the client interface to include a display of the first product that is capable of being selected by the client is performed responsive to identifying the flag associated with the client identifier.

8. A non-transitory machine-readable medium having machine executable instructions stored thereon that, when executed by one or more processors, direct the one or more processors to perform a method comprising:
generating a client interface to be presented on a client device associated with a client;
retrieving client information associated with the client from a client information database based on identifying at least one entry that corresponds with the client;
detecting a request from the client device to generate a new account for the client;
generating the new account by mapping information relating to the new account with a client identifier associated with the client;
storing the information relating to the new account and the client identifier in an account database; and
updating the client interface to indicate that the new account is available to the client.

9. The non-transitory machine-readable medium of claim 8, wherein the client interface includes a series of buttons indicative of account tasks capable of being performed for the client, and wherein detecting the request includes detecting a single action includes a selection of a first button of the series of buttons on the client interface corresponding to generating the new account.

10. The non-transitory machine-readable medium of claim 8, further comprising:
transmitting a request for client information to multiple third-party devices, wherein the request is encrypted and includes the client identifier;
receiving requested client information from the multiple third-party devices;
deriving a type of information included in the requested client information; and
storing the requested client information in the client information database based on the derived type of information of the requested client information.

11. The non-transitory machine-readable medium of claim 8, further comprising:
detecting an indication on the client interface indicating a request for presentation of products on the client interface; and
setting a flag associated with the client identifier, wherein updating the client interface to include a display of the first product that is capable of being selected by the client is performed responsive to identifying the flag associated with the client identifier.

12. The non-transitory machine-readable medium of claim 8, wherein each button of a series of buttons on the client interface relates to a different account type, and wherein selection of the first button indicates a request to open the new account of a first account type.

13. The non-transitory machine-readable medium of claim 8, further comprising:
for each account type of a series of account types, comparing the client information with a set of qualification criteria indicative of whether the client is qualified for each account type, wherein generating the new account by mapping information relating to the new account with a client identifier associated with the client is performed responsive to determining that the client is qualified for a first account type associated with the new account.

14. A system for automatically generating a new account for a client, the system comprising:
a server configured to:
generate a client interface to be presented on a client device associated with the client;
retrieve client information associated with the client from a client information database based on identifying at least one entry that corresponds with the client;
detect a request from the client device to generate the new account for the client, the request comprising a single action on the client interface presented on the client device;
generate the new account by mapping information relating to the new account with a client identifier associated with the client;
store the information relating to the new account and the client identifier in an account database; and
update the client interface to indicate that the new account is available to the client.

15. The system of claim 14, the server further configured to:
transmitting a request for client information to multiple third-party devices, wherein the request is encrypted and includes the client identifier;
receiving requested client information from the multiple third-party devices;
deriving a type of information included in the requested client information; and
storing the requested client information in the client information database based on the derived type of information of the requested client information.

16. The system of claim 14, wherein the client interface includes a series of buttons indicative of no application account tasks capable of being performed for the client, and wherein the single action includes a selection of a first button of the series of buttons on the client interface corresponding to generating the new account.

17. The system of claim 14, wherein generating the new account further includes populating account description fields using client information maintained by the client information database.

18. A method performed by a system to dynamically generate a new account for a client, the method comprising:
retrieving client information associated with the client from a client information database based on identifying at least one entry that corresponds with the client;
presenting a client interface on a client device, the client interface including the client information retrieved from the client information database and a series of buttons, each button indicative of one of various account types;
detecting a single action of a selection of a first button of the series of buttons indicative of a request to create an account of a first account type;
retrieving account information that relates to the first account type from an account information database;
mapping the client information and the account information relating to the first type to generate the new account for the client of the first account type;
storing the new account, the client information, and the account information relating to the first type in a client account database; and
updating the client interface to indicate that the new account is available to the client.

19. The method of claim 18, further comprising:
transmitting a request for client information to multiple third-party devices, wherein the request is encrypted and includes a client identifier;
receiving requested client information from the multiple third-party devices;
deriving a type of information included in the requested client information; and
storing the requested client information in the client information database based on the derived type of information of the requested client information.

20. The method of claim 18, wherein generating the new account further includes populating account description fields using client information maintained by the client information database.

21. A non-transitory machine-readable medium having machine executable instructions stored thereon that, when executed by one or more processors, direct the one or more processors to perform a method comprising:
presenting a client interface including client-specific information and a series of buttons, each button indicative of one of various account types;
detecting a single action of a selection of a first button of the series of buttons indicative of a request to create an account of a first account type;
retrieving account information that relates to the first account type from an account information database;
mapping the client information and the account information relating to the first type to generate a new account of the first account type; and
updating the client interface to indicate that the new account is available to a client.
